(19) United States
(12) Patent Application Publication
(10) Pub. No.: US 2009/0008267 A1
(43) Pub. Date: Jan. 8, 2009

(54) PROCESS AND METHOD FOR THE REMOVAL OF ARSENIC FROM WATER

(76) Inventor: Giovanni Del Signore, Firenze (IT)

Correspondence Address: GIOVANNI DEL SIGNORE, VIA SAN MATTEO IN ARCETRI, 25, FIRENZE, 50125, IT

(21) Appl. No.: 11/773,460

(22) Filed: Jul. 5, 2007

(51) Int. Cl. C02F 1/461

(52) U.S. Cl. 205/744; 205/752; 205/756

(57) ABSTRACT

This invention describes a one step process for the removal of heavy metals, particularly arsenic, from water. The process consists in promoting the circulation of the water to be treated in an electrolytic cell equipped with iron, or iron alloy anodes and cathodes made of iron or iron alloy or other metals, while the contemporary insufflation into the cell of a gas, partially or totally composed of oxygen. In this way the iron of the anode electrodes dissolves as iron hydroxide. The ferrous hydroxide thus generated, under the action of the oxygen contained in the insufflated gas is converted to ferric hydroxide, which, through a complex mechanism, adsorbs and forms insoluble complexes with the arsenic ions. At the same time As(III) is subject to oxidation both at the anode and at the cathode. By this process both forms of arsenic, As(III) and As(V), are equally removed. The treated water is further processed by conventional clarifying and filtering.

### BACKGROUND OF THE INVENTION

This invention relates to a process and apparatus for the removal of heavy metals, particularly arsenic, from water.

The presence of arsenic in natural waters is well known on different parts of the world, including Chile, China, Taiwan, Mexico, USA, some regions in Europe, and particularly severe in Bangladesh and West Bengal, north of India. The concentration levels may reach in some cases values up to 70 times the maximum permissible level of 50 μg/l (Bangladesh and Indian standard). It is argued that only in Bangladesh and West Bengal more than 30 Million people live at risk of severe illnesses, like skin, liver and bladder cancer, induced by arsenic contamination of drinking water.

The removal of arsenic from water is based mainly on the following processes:

Nanofiltration (including reverse osmosis)

Electrodyalisis

Absorption on solid surfaces

Absorption with formation of insoluble complexes that can be removed by settling and filtration.

Any pollutant removal process, therefore also arsenic remediation from water, has to face the main problem of the disposal of the by-products produced from said processes.

Reverse Osmosis (RO) has a high removal efficiency but has the drawback that the primary water becomes highly polluted, with concentrations even higher than the water before treatment.

Electrodyalisis presents nearly the same problems of the RO process, with higher costs.

Absorption on solid surfaces, like activated Alumina has a very good removal efficiency but at critical pH values. Therefore this process needs a strict pH monitoring and control. Moreover the spent Alumina presents disposal problems during its regeneration.

The absorption process with the formation of insoluble complexes that may be removed by settling and filtration is undoubtedly, from a practical point of view, the most convenient because of its reasonable costs and safety in sludge disposal.

The processes of this type, currently employed, are based on the adsorption and/or coagulation followed by settling and filtration. These processes are based on the dissolution in water of iron or aluminium ions. In the case of iron (preferable to aluminium) the ferrous and ferric hydroxides combine chemically with metal ions (in this case arsenic) forming compounds like ferric arsenate and complexes of hydrous ferric oxide and arsenic acid. These compounds are water insoluble and can be easily removed by precipitation and filtration. The resulting sludge is stable and can be safely disposed, as usual, without any other successive treatment.

In natural waters arsenic is usually found in two forms, as trivalent and pentavalent arsenic. The As(III) is found mainly in ground water, and it is the most poisonous form. It is supposed to originate from the oxidation (contact with air) of arsenious rocks. The As(V) is found mainly in surface waters and is the product of the oxidation of As(III) mainly due to the presence of dissolved oxygen. In natural ambient conditions this oxidation proceed at an extremely slow rate. In laboratory As(III) can be easily oxidised to As(V) with, for example, chlorine, ozone or hydrogen peroxide.

There are also some organic forms (Methylated Arsenicals), like Monomethylarsenate (MMA) or Dimethyilarsenate (DMA), found in surface waters due to herbicides contamination.

The process for the removal of Arsenic from water at present currently employed consists of the following steps: i) addition of an oxidant (like chlorine) to convert As(III) to As(V), ii) addition of a coagulant, for instance ferric chloride. At low concentrations and neutral pH ferric chloride hydrolyses to ferric hydroxide that absorbs arsenic ions, forming, as explained, Fe-As complexes. This complexes are insoluble forming flocks which precipitate, iii) the treated water is passed in a flocculator and clarifier and finally filtered, leaving it ready for use.

This process needs the use of chemical products: oxidants for the oxidation of As(III), acid and bases for pH control and possibly flocculant coadjutant and process control systems. The aforesaid process is the most popular because it has a good removal efficiency (more than 90%) and has the advantage of producing a sludge that meets the test limits of TLCP (Toxicity Characteristic Leaching Procedure, EPA).

There exists a bibliography regarding this process:

Y. S. Shen, Study of Arsenic Removal from Drinking Water, JAWWA, August 1973, 543;

John Gulledge and John T. O'Connor, Removal of Arsenic (V) from Water by Absorption on Aluminium and Ferric Hydroxides, JAWWA, August 1973, 548.

Another process, as described in the U.S. Pat. No. 5,368,703 uses Ferrous ions Fe(++) electrochemically generated in an electrolytic cell with bipolar electrodes of Iron (or alloy containing Iron). The anodic part of the electrodes dissolves as Ferrous (++) ions. The electrochemical reaction takes place directly into the water to be treated. The water that contains the Ferrous (++) ions is transferred into a reactor vessel where, after pH adjustment, it is added with Hydrogen Peroxide (H2O2). In this way As(III) is oxidised to As(V) and the Ferrous Hydroxide is also oxidised to Ferric Hydroxide. This latter coagulates forming flocks in which As ions are adsorbed as complexes with the Ferric ions, this is similar to what happens with Ferric Chloride. The flocks are precipitated and filtered from the purified water.

### SUMMARY OF THE INVENTION

The principal aim of this invention is to propose a one step method for the removal of heavy metals from water, and particularly Arsenic, with the help of iron hydroxides electrolytically generated but carried out in a more simplified way.

In the context of this task one of the aims of this invention is to propose a process which does not need any chemical products nor pH adjustments.

Another aim of this invention is to propose a process that, particularly in presence of Arsenic, is capable to remove very efficiently either trivalent As(III) and pentavalent As(V).

This task, together with other tasks which will be described further on, are performed by means of a process for the removal of heavy metals from water, particularly Arsenic. In this process the water is circulated in a electrolytic cell between a plurality of electrodes. More specifically said electrodes are composed of anodes made of iron or iron alloys and cathodes made of iron or iron alloys or other metals like stainless steel or titanium. In addition to this a gas containing oxygen, for example air, is insufflated trough and between said electrodes. The water treated in this way is subsequently passed trough a flocculator and/or filter.

The process, object of this invention, is preferably carried out with an apparatus that includes: an electrolytic as described above; and an inlet connection for the water to be treated and an outlet connection for the treated water; means for circulating the water inside the electrolytic cell; means to insufflate the gas containing oxygen into the electrolytic cell.

Further characteristics and advantages of the present invention will follow from the description of experimental examples.

### BRIEF DESCRIPTION OF THE FIGURES

FIG. 1 illustrates a schematic diagram for performing the process object of this invention, it comprises:

an electrolytic cell 1, with a plurality of electrodes 2 of iron, or iron alloy, or steel (subdivided in anodes and cathodes); two hydraulic connections, one inlet 3 for the water to be treated, and one outlet 4 to extract the treated water; a pump 5 for circulating the water inside the electrolytic cell in order to increase the residence time of the water to be treated in contact with the electrodes; means to insufflate a gas containing oxygen 6 into the electrolytic cell; a constant current d.c. power supply 7 to deliver an electric current to the electrodes. In this figure the electrodes are assembled in a parallel, or monopolar, configuration.

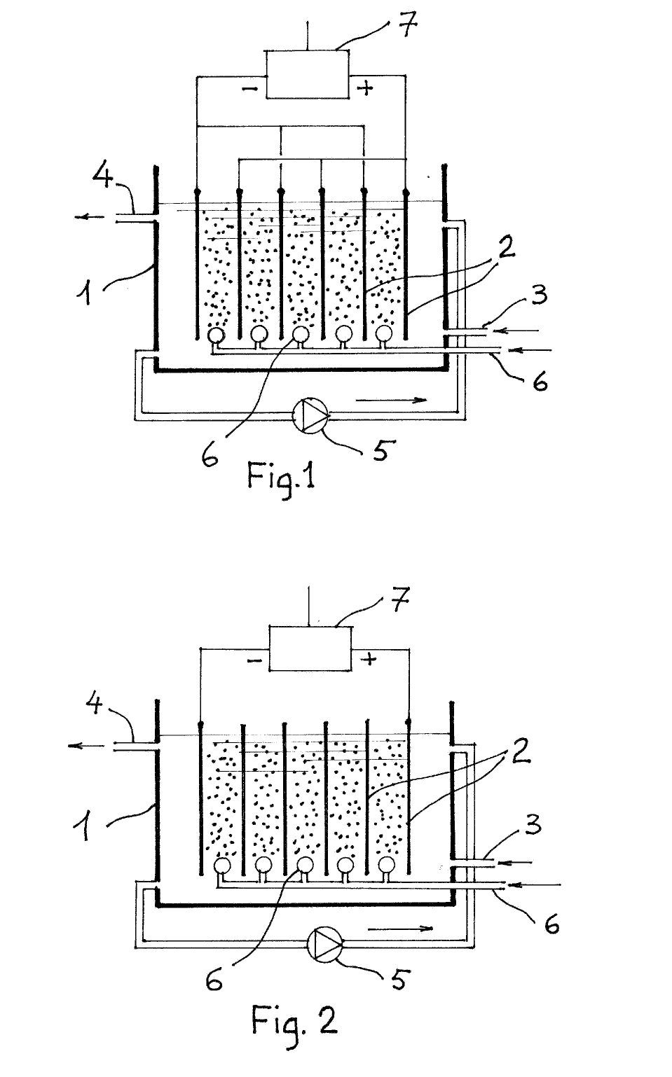

FIG. 2 illustrates the same diagram of FIG. 1 except for the electrodes configuration which, in this figure, is of the bipolar type.

### DETAILED DESCRIPTION OF THE INVENTION

In detail the method object of this invention can be fulfilled by means of an electrolytic cell composed of a plurality of electrodes and specifically anodes of iron or iron alloy, and cathodes either of iron, or iron alloy like stainless steel or other metals like titanium coated with noble metals oxides (Ru, La, Ti), or valve metal.

The electrode assembly can be composed of two or more electrodes, connected to an electric power supply, with interposed a number of electrodes without electric connections, i.e. bipolar electrodes, a configuration well known by any expert on this field. Another configuration consists of a number of electrodes where the anodes are connected in parallel and the cathodes are connected in parallel (monopolar configuration). A dc voltage, generated by means of a constant current power supply, is applied to the anode (or anodes) and to the cathode (or cathodes). In this way an electric current flows through the entire electrolytic cell. This is due to the fact that water contains always some dissolved ions (Na⁺, SO₄⁻⁻, Ca⁺⁺, NO₃⁻, etc.) that contribute to the electric conductivity of water. The current density should be in the range of 2-20 mA/cm², referred to the electrodes surface area. The electrolytic cell is of the undivided configuration, i.e. without any membrane or diaphragm between anode and cathode. Moreover the electrolytic cell should be equipped with an oxygen containing gas (air or pure oxygen) sparging facility. In case the electrode plates are placed vertically the gas should be insufflated at their bottom into each space between the anode and cathode plates. In case the electrodes are placed horizontally the gas should be insufflated trough the electrode plates made of expanded mesh. In this case the gas should injected uniformly over the entire surface of the electrodes. Another imperative is that the gas should be injected finely divided so that the oxygen can be quickly dissolved in the water. The flow rate of gas containing oxygen should be as to nearly saturate the treated water. The water during the treatment should be recirculated several times inside the electrolytic cell (by means of a pump) in order to increase the contact time with the electrodes. For this purpose, if necessary, it is possible to interpose a tank in the recirculation loop. The role of the oxygen contained in the gas is fundamental because it causes the oxidation of Fe(II) to Fe(III), the last forming the ferric hydroxide, highly insoluble and the main responsible for Arsenic removal. Furthermore it should be pointed out that with the process of this invention, the removal efficiency of As(III) is the same as for As(V): no previous oxidation is necessary to convert As(III) to As(V). This is opposed to the knowledge to date. This is due to an oxidation mechanism of As(III) to As(V) due to the combined action of the oxygen contained in the insufflated gas and a secondary oxidation mechanism.

This mechanism can be summarised as follows. At the anode electrochemical oxidation takes place of iron Fe(0) to Fe(II) and the generation of Ferrous Hydroxide Fe(OH)₂:

Fe(0)→Fe(II)+2 e⁻

2OH⁻+Fe−2 e⁻→Fe(OH)₂

The Faradic efficiency of this reaction is practically one: 1 A*h for 1.042 g of Fe(II).

Under the action of oxygen dissolved in the water Fe(II) is oxidised to Fe(III):

Fe(II)+¼O₂+H₂O→Fe(III)+¼H₂O+OH⁻

Fe(III)+3 H₂O→Fe(OH)₃+3 H⁺

To account for the oxidation of As(III) a mechanism that involves the action of Fe(II) in presence of oxygen has been proposed ^{[1,2]}. Oxidation of Fe(II) by dissolved oxygen involves the formation of oxidising intermediates (⁻O₂⁻, H₂O₂, and OH or Fe(IV)) some of which could oxidise As(III):

As(III)+intermediates (⁻OH, Fe(IV))→As(IV)

As(IV)+O₂→As(V)+⁻O₂⁻

The oxidation of As(III) is optimal with prolonged low steady-state concentration of Fe(II), which is continuously oxidised by dissolved oxygen ^{[1]}. The continuous action of electric field on the anode and dissolved oxygen (from insufflated oxygen rich gas) provide the right conditions for the oxidation of As(III). The As(V) thus generated is adsorbed on Fe(OH)₃, which, being strongly insoluble in water with a pH around neutrality, forms large flocks and easily precipitates. The precipitated ferric hydroxide Fe(OH)₃ carrying the adsorbed arsenic can be concentrated in a flocculator (tubular or plate type, or any other) and successively filtered (filter press, membrane, sand, etc.), or else directly filtered. The concentrated sludge is stable and satisfies the TLCP (EPA) test, therefore it can disposed, without any additional treatment, into appropriate dumps, provided it is maintained at neutral or alkaline pH. It has been demonstrated that the process of this invention fully satisfies the proposed task: in one single step performed with the dissolution of an iron anode in an electrolytic cell with insufflation of air (or a gas containing oxygen) it is possible to remove both kind of arsenic, trivalent and pentavalent, without the need of any additional chemical product, nor adjustment of the pH, provided the pH of the water to be treated is in the range from 6 to 8. The energy needed to power the process of this invention is relatively low, as will be shown in the example described below. The current density on the electrode plates may vary from a few mA/cm² to a few tens mA/cm². Therefore, knowing that the Faradic efficiency is practically one, the amount of bivalent iron, Fe(II), produced (or equivalently, dissolved) is approximately 1 mg for every mA.hour of current delivered to the cell. As an example, considering a voltage of 7 Volts applied between anode and cathode, the energy necessary to produce (or dissolve) 1 g of iron is 7 Watt.hour. To remove arsenic to 99% the Fe/As ratio (resulting from laboratory tests) must be around 25 and more. Therefore considering an amount of 100 L of water to be treated with an arsenic concentration of 1 mg/L, to remove it down to 25 μg/L one needs 2.5 g of dissolved iron which is equivalent to an energy consumption of 17.5 W.h.

For 10,000 L the energy needed is 1.05 kW.h. Obviously this energy is needed only for the electrolytic cell to which must be added the energy for the pumps, control circuitry, conversion losses, etc.

The electrolytic cell operates in a continuous flow mode. Electric supply (d.c. direct current), therefore must be set to a value as to continuously produce a quantity of ferric hydroxide Fe(OH)₃ in order to have the right Fe/As ratio to remove the arsenic in the water to be treated. This can easily be accomplished by simply varying the current through the electrolytic cell. This is a great advantage with respect to other removing techniques because the ferric hydroxide can be dosed by simply varying the cell current: no dosing of other chemicals is necessary. Moreover in order to avoid deposits of alkaline hydroxides (scale) on the cathodes the polarity of the current delivered to the cell can be reversed for a short wile at regular intervals. Another advantage of this invention is that in this process added flocculants, like alum or ferrous salts used in conventional processes, are not necessary.

### EXPERIMENTAL EXAMPLES

### Example N.1

An electrolytic cell was assembled as illustrated in FIG. 1. The electrodes were obtained from commercial mild steel sheet. The anode measured 3.5×7 cm. Facing two identical cathodes of the same size. The resulting active area was therefore 49 cm². The gap between anode and the two cathodes was 4.0 mm. The electrodes were place vertically in an insulating container. At the base and under the electrodes a ceramic porous candle was placed and connected by means of a flexible plastic tube and flow meter to a compressed air supply. The test water to be spiked with arsenic had the following characteristic:

pH=7.08; hardness=49.3° F.; conductivity=590 μS; D.O.=5.6 mgL⁻¹ at 17.6° C.;

Ca 110 mgL⁻¹; NO₃ 59.7 mgL⁻¹; SO₄ 88 mgL⁻¹; Fe (total) 14 μL⁻¹; Mn 1.0 μgL⁻¹; Mg 52.7 mgL⁻¹. This water was then spiked with Sodium Arsenite resulting a total As concentration of 1.1 mgL⁻¹. The speciation gave 1.046 mgL⁻¹ of As(III), the spiked water thus contained only 54 μgL⁻¹ of As(V). The electric current through the cell was set at 245 mA, corresponding to a current density of 5 mA/cm². The weight loss of the anode (or equivalently the amount of iron dissolved) was determined by weight difference of the anode, which was 1.0±5% g/Ah (Ampere×hour), in accordance with Faraday law (theoretical value 1.042 g/Ah) demonstrating that the dissolved species is Fe(II). Using one litre of spiked water each time, five tests were performed for time intervals of 3. 6, 8. 10, and 12 minutes. Air was insufflated at a rate of 3.5 L/min. At the end of each run the treated water was immediately filtered through a pyrex glass filter (porosity 4). The results are shown on the following table and FIG. 2:

| Time | | | | | Dissolved |
|---|---|---|---|---|---|
| interval | | Released Iron | Total As | pH | Oxygen |
| Minutes | mA.h | Hydroxides mg/L | μg/L | final | mg/L |
| 3 | 12.25 | 12.8 | 100 | 7.10 | 7.8 |
| 6 | 24.50 | 25.6 | 25 | 7.15 | 7.7 |
| 8 | 34.04 | 35.47 | 15 | 7.35 | 7.55 |
| 10 | 40.83 | 42.55 | 12 | 7.60 | 7.6 |
| 12 | 49.0 | 51.06 | 9.1 | 7.72 | 7.75 |

As can be seen the removal efficiency is very good only for Fe/As ratios greater than 40. This is due mainly to the high content of sulfate and nitrate.

To confirm these results a validation test was performed with three procedures: electrolytic+air insufflation; electrolytic without air insufflation, and chemical (using FeCl₃.6H₂O150).

The following table shows the results of the first two tests:

Water spiked with 4.12 mg/L (NaAsO₂): 150 mL; filtration after
20 minutes

| | | Released Iron | Total | | Dissolved |
|---|---|---|---|---|---|
| Time interval | | Hydroxides | As | | Oxygen |
| Minutes | mA · h | mg/L | μg/L | Fe/As | mg/L |
| 4 (with air) | 6.87 | 47.7 | 80 | 11.58 | 7.42 @ 25° C. |
| 4 (without air) | 6.87 | 47.7 | 480 | 11.58 | 2.05 @ 25° C. |

The chemical tests were performed as follows: 150 mL of tap water (potable water from city grid) was spiked to 4.12 mg/L with NaAsO₂ and added with 10 mL of H₂O₂ (3.6%) and left for 10 minutes to oxidise all As(III) to As(V). A quantity of 7.44 mg of equivalent Fe (from FeCl₃.6H₂O) was then added having thus a concentration of 49.6 mg/L. The Fe/As ratio is therefore 12.04. The pH was adjusted with NaOH to 7.65. Filtration was performed after 20 minutes, like the tests made with electrolysis. Arsenic found was 83 μg/L. As can be seen the removal coefficient is 0.98, the same as with electrolysis+air test. From both tests (electrolytic and chemical) it results that the oxidation of As(III) is fundamental. As a proof a second chemical test was performed at the same conditions but without the previous oxidation of As(III) with H₂O₂. The arsenic left was approximately 500 μg/L.

### Example N.2

Based on this results a small pilot plant has been assembled. The main parts are: the electrolytic cell made of two disc shaped perforated steel plates, placed horizontally (air bubbles pumped through a ceramic diffuser cross the two perforated electrodes); an upflow gravel flocculator and a sand filter. Flow rate can be varied from 10 to 100 1/h. In the following tests flow was set at 501/h. The hydraulic residence time in the electrolytic cell was 4.5 min. The water used for this experiment was the same as the one for the first experiment: it was first deoxygenated and then spiked with Sodium Arsenite (NaASO₂) to the concentrations shown in the first column of the table below. Here are the results of a series of preliminary tests.

| | | | As | As | As |
|---|---|---|---|---|---|
| Input | | | concentration | concentration | concentration at |
| water | Fe | Fe | immediately | water filtered | flocculator and sand |
| As(III) | concentration | yield | after filtration | after 1 hour | filter output, μg/L |
| μg/L | mg/L | mg/h | μg/L | μg/L | (% removal) |
| 937 | 28.9 | 1445 | 123 | 42 | 44 (95.3%) |
| 636 | 16.15 | 807 | 103 | 81 | 71 (88.8%) |
| 696 | 33.5 | 1675 | 68 | 47 | 20 (97.1%) |

The operating conditions were:

for the first row: cell voltage 6.2 V.; cell current 1.5 A.; el. energy input 9.3 Wh, for the second row: cell voltage 4.3 V.; cell current 0.9 A.; el. energy input 3.87 Wh, for the third row: cell voltage 6.6 V.; cell current 1.7 A.; el. energy input 11.22 Wh.

This novel process is a modification of well known removal processes, namely electrocoagulation and chemical coagulation with iron salts. By combining the electrolytic dissolution of iron in water with air insufflation As(V) is directly adsorbed on ferric hydroxide, and As(III) being at the same time oxidised to As(V). This process is simple, does not need any added chemicals, the removing efficiency is excellent, therefore it could be a promising technology for the detoxication of arsenicated drinking water.

^{[1]} Leupin, O. X., Hug, S. J., Oxidation and removal of As(III) from aerated groundwater by filtration through sand and zerovalent iron. Water Res. 2005. 39,1729-1740.

^{[2]} S. J., Hug, O. Leupin, Iron-Catalyzed Oxidation of Arsenic(III) by Oxygen and Hydrogen Peroxide: pH dependent Formation of Oxidants in the Fenton Reaction. Environ. Sci. Technol. 2003, 37, 2734-2742.

1. Method and process for the removal of heavy metals, particularly arsenic, from water, comprising:
a) an electrolytic cell filled with the water to be treated and equipped with one or a plurality of electrodes subdivided in anodes and cathodes, said anodes being dissolved under the action of an electric current flowing from the anodes to the cathodes.
b) the insufflation of oxygen, or a gas containing oxygen, injected into the space between every anode and cathode couple.

2. Method and process according to claim 1 wherein said electrolytic cell is equipped with iron, or iron alloy metal, anodes, and cathodes also made of iron, or iron alloy metal, or else of other metals like stainless steel, nickel or titanium, or titanium coated with noble metal oxides hawing low hydrogen overpotential.

3. Method and process according to claim 1 wherein the electrolytic cell can operate in batch mode or continuous flow mode, in both cases said cell being equipped with an inlet and an outlet for the water to be treated.

4. Method and process according to claim 1 wherein the current applied to said electrodes has a density ranging from 5 to 20 mA/cm² referred to said electrodes surface area.

5. Method and process according to claim 1 wherein the current applied to said electrodes produces the dissolution of a quantity of iron that is constant in time and whose concentration in water is such that the Fe/As ratio equals a preset value.

6. Method and process according to the preceding claim wherein said Fe/As ratio has a value comprised between 10 and 60, according to the quality of the water to be treated.

7. Method and process according to claim 1 wherein the quantity of oxygen supplied to the water to be treated must be equal or larger than the stoichiometric value necessary for the oxidation of the iron dissolved at the anode(s) in the form of Ferrous Hydroxide (Fe(OH)₂).

8. Method and process according to the preceding claims wherein the dissolved oxygen concentration in the water to be treated should always be near saturation.

9. Method and process according to the preceding claims wherein the water to be treated is recirculated many times trough said electrolytic cell with appropriate means.

10. Method and process according to claim 7 wherein the water recirculated through said cell passes through an auxiliary storage tank in order to increase its residence time in said electrolytic cell.

11. Method and process according to claim 1 wherein said gas containing oxygen is air.

12. Method and process according to the preceding claims wherein means for circulating the water through said electrolytic cell, and means for insuffiating a gas containing oxygen into said electrolytic cell are provided.

13. Method and process according to the preceding claims wherein it includes means for the settling and filtration of the water flowing out from said cell.

14. Method and process for the removal from water of heavy metals, particularly arsenic, as described and illustrated above.
